(19) United States
(12) Patent Application Publication
(10) Pub. No.: US 2026/0311213 A1
(43) Pub. Date: Oct. 8, 2026

(54) ADVERTISEMENT APPARATUS

(71) Applicants: Takahito SAIGO, Iwate (JP); Masato Ikeda, Saitama (JP); Yukihiro Takasa, Kanagawa (JP)

(72) Inventors: Takahito SAIGO, Iwate (JP); Masato Ikeda, Saitama (JP); Yukihiro Takasa, Kanagawa (JP)

(21) Appl. No.: 19/563,598

(22) Filed: Mar. 11, 2026

Related U.S. Application Data
(63) Continuation of application No. 17/269,473, filed on Dec. 18, 2018.

(30) Foreign Application Priority Data
Nov. 21, 2018 (JP) 2018-218059

(51) Int. Cl. G06Q 30/0251

(52) U.S. Cl. CPC G06Q 30/0255; G06Q 30/0269

(57) ABSTRACT

An advertisement apparatus includes: means for acquiring user terminal identification information, user identification information, and user terminal record information including position information and operation record information on a user terminal; means for acquiring the user identification information and purchasing behavior information relevant to purchasing of an item/service that are acquired by a shop terminal provided in a real shop; storage means for storing the user terminal identification information, the user terminal record information, the purchasing behavior information, and user attribute information in association with each other by the user identification information; means for generating advertisement information on the basis of an analysis result obtained by analyzing the information stored in the storage means; and notification means for specifying the user terminal identification information and an advertisement application and giving notification of the advertisement information.

### CROSS-REFERENCE TO RELATED APPLICATIONS

This application is a continuation of U.S. application Ser. No. 17/269,473 filed on Feb. 18, 2021, which is a National Stage Entry of PCT International Patent Application No. PCT/JP2018/046547 filed on Dec. 18, 2018, claiming the benefit of priority of Japanese Patent Application No. 2018-218059 filed on Nov. 21, 2018. The entire disclosures of the above-identified applications, including the specifications, drawings, and claims are incorporated herein by reference in their entirety.

### TECHNICAL FIELD

The present invention relates to a technology to give notification of advertisement information to a user terminal and verify the effect of the advertisement information.

### BACKGROUND ART

An advertisement is a positive and extensive announcement of information on items or services to the public and aims to promote the sales of the items/services.

Conventionally, advertisements for items or services have been often placed. However, it has been difficult to place effective advertisements and verify the effect of the advertisements with high accuracy.

In such a circumstance, technologies to enhance the effect of advertisements have been actively developed. For example, Patent Literature 1 proposes a technology to properly determine advertisements to be distributed. Further, Patent Literature 2 proposes a technology to acquire information on customers and information on items purchased at real shops in association with each other and accumulate the same.

### CITATION LIST

### Patent Literature

PTL 1: Japanese Patent No. 6125700
PTL 2: Japanese Patent No. 6026682

### SUMMARY OF INVENTION

### Technical Problem

However, the above conventional technologies cannot give notification of advertisements assumed to be highly effective and verify the effect of the advertisements in consideration of user's statuses and preference tendencies.

In view of this, the present invention has an object of providing an advertisement apparatus that can give notification of advertisements assumed to be highly effective and verify the effect of the advertisements in consideration of user's statuses and preference tendencies.

### Solution to Problem

An embodiment of a disclosed advertisement apparatus includes: user terminal information acquisition means for acquiring user terminal identification information, user identification information, and user terminal record information that are collected by a user terminal from the user terminal, the user terminal identification information being information used to specify the user terminal when the user terminal and an application installed in the user terminal are specified to give notification of an advertisement, the user identification information identifying a user who operates the user terminal, user terminal record information including position information and operation record information on the user terminal; purchasing behavior information acquisition means for acquiring the user identification information and purchasing behavior information that are acquired by a shop terminal provided in a real shop that sells an item/service from the shop terminal, the purchasing behavior information being information relevant to purchasing of the item/service at the real shop by the user; user information storage means for storing the information acquired by the user terminal information acquisition means and the purchasing behavior information acquisition means and user attribute information in association with each other by the user identification information, the user attribute information including a name, a birth date, a gender, and an address of the user; advertisement information generation means for generating advertisement information on a basis of an analysis result obtained by analyzing the information stored in the user information storage means, the advertisement information being notified to an advertisement application that is installed in the user terminal identified by the user terminal identification information and capable of receiving an advertisement; and advertisement information notification means for specifying the user terminal identification information and the advertisement application and giving notification of the advertisement information generated by the advertisement information generation means.

### Advantageous Effects of Invention

A disclosed advertisement apparatus can give notification of advertisements assumed to be highly effective and verify the effect of the advertisements in consideration of user's statuses and preference tendencies.

### BRIEF DESCRIPTION OF DRAWINGS

FIG. 1 is a diagram for describing the outline of an advertisement apparatus according to the present embodiment.

FIG. 2 is a function block diagram of the advertisement apparatus according to the present embodiment.

FIG. 3(a) to 3(c) are diagrams showing an example of information acquired by user terminal information acquisition means according to the present embodiment.

FIG. 4 is a diagram showing an example of information acquired by purchasing behavior information acquisition means according to the present embodiment.

FIG. 5 is a diagram showing an example of user attribute information according to the present embodiment.

FIG. 6 is a diagram for describing processing by advertisement information generation means and advertisement information notification means according to the present embodiment.

FIG. 7 is a diagram showing a hardware configuration example of the advertisement apparatus according to the present embodiment.

FIG. 8 is a flowchart showing the flow of an example of processing to acquire user terminal record information by the advertisement apparatus according to the present embodiment.

FIG. 9 is a flowchart showing the flow of an example of processing to acquire purchasing behavior information by the advertisement apparatus according to the present embodiment.

FIG. 10 is a flowchart showing the flow of am example of processing to verify the generation/notification/effect of advertisement information by the advertisement apparatus according to the present embodiment.

### DESCRIPTION OF EMBODIMENTS

An embodiment for carrying out the present invention will be described with reference to the drawings.

### Principle of Operational of Advertisement Apparatus According to Present Embodiment

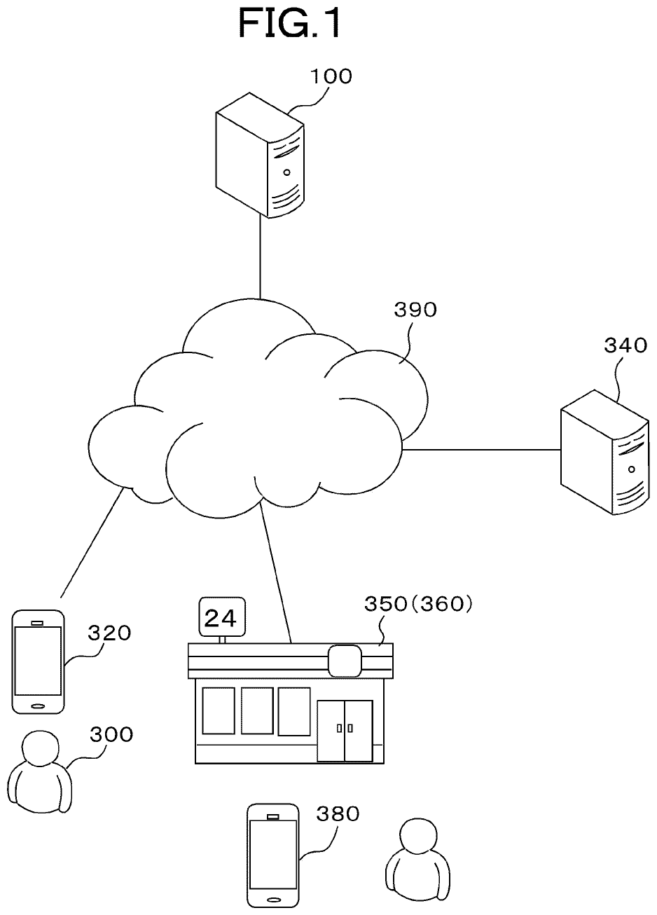

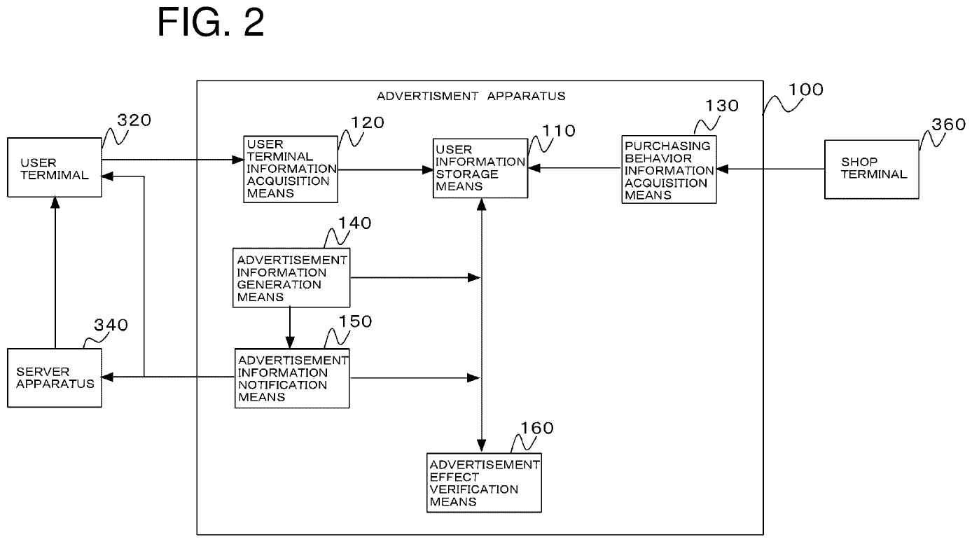

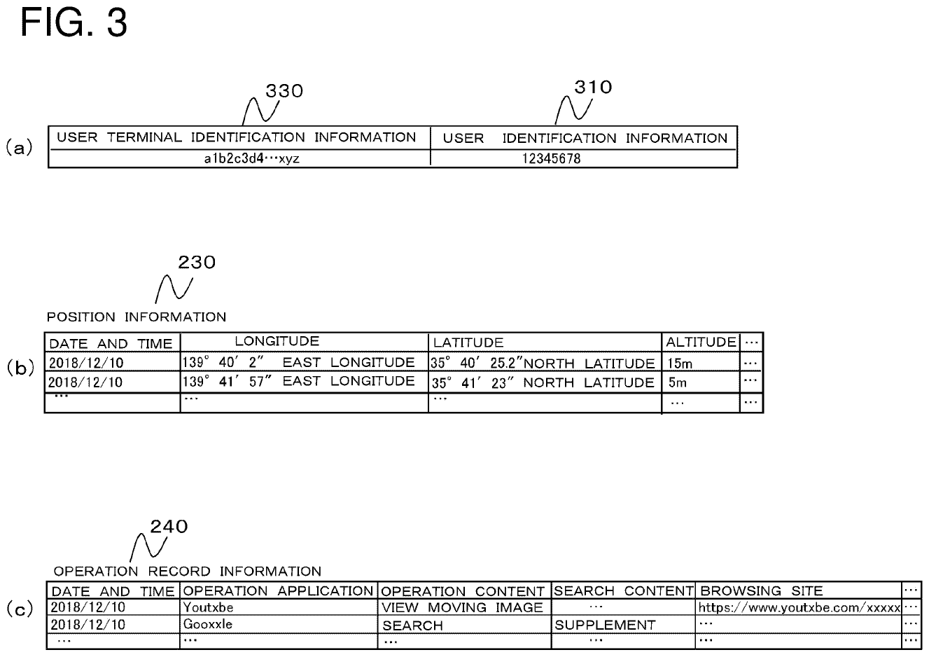

The principle of the operation of an advertisement apparatus (hereinafter simply called the “present apparatus”) 100 according to the present embodiment will be described using FIGS. 1 to 6. FIG. 1 is a diagram showing the connection relationship between the present apparatus 100 and peripheral apparatuses, and FIG. 2 is a function block diagram of the present apparatus 100. FIG. 3(a) to 3(c) to FIG. 6 are diagrams for describing respective processing in the present apparatus 100.

As shown in FIG. 1, the present apparatus 100 is connected via a communication network 390 to a user terminal 320 that is operated by a user 300, a shop terminal 360 that is provided in a real shop 350 that sells items/services 280, and a server apparatus 340 that manages the distribution of advertisements to an advertisement application 290.

The communication network 390 may be a wired or wireless type. The form of the user terminal 320 is not particularly limited so long as the user terminal 320 is a computer having a communication function but is preferably a mobile information terminal such as a smartphone. The advertisement application 290 is application software that is installed in the user terminal 320 and can receive advertisement information 210. The advertisement information 210 notified to the advertisement application 290 is browsed by the user 300 via a display device provided in the user terminal 320.

The present apparatus 100 receives user terminal identification information 220, user identification information 310, and user terminal record information 220 that are collected by the user terminal 320 and notified from the user terminal 320 at prescribed timing. The present apparatus 100 receives the user identification information 310 and purchasing behavior information 250 that are collected by the shop terminal 360 and notified from the shop terminal 360 at prescribed timing. On the other hand, the present apparatus 100 retains user attribute information 260 in advance.

The present apparatus 100 analyzes the user terminal identification information 330, the user terminal record information 220, the purchasing behavior information 250, and the user attribute information 260 that are associated with each other by the user identification information 310 serving as a key, and generates the advertisement information 210 that is assumed to enhance an effect. Then, the present apparatus 100 specifies the user terminal identification information 330 and the advertisement application 290 and gives notification of the advertisement information 210 to motivate the user 300 to enhance a purchasing inclination. Further, the present apparatus 100 can verify the effect of the advertisement information 210 with high accuracy since the present apparatus 100 collects the use status of the advertisement information 210 as the purchasing behavior information 250 on the user 300. Note that the advertisement information 210 may be notified via the server apparatus 340 different from the present apparatus 100 or may be directly notified from the present apparatus 100.

As described above, the present apparatus 100 can give notification of the advertisement 210 assumed to be highly effective and verify the effect of the advertisement 210 in consideration of the current statuses 220 and 260 and the preference tendency 250 of the user 300.

The present apparatus 100 has user information storage means 110, user terminal information acquisition means 120, purchasing behavior information acquisition means 130, advertisement information generation means 140, advertisement information notification means 150, and advertisement effect verification means 160.

The user information storage means 110 stores the user terminal identification information 330, the user terminal record information 220, the purchasing behavior information 250, the user attribute information 260, and examination result information 270 in association with each other by the user identification information 310. The user terminal identification information 330 is information used to specify the user terminal 320 when the application 290 installed in the user terminal 320 is specified to give notification of the advertisement 210, and is mentioned as a so-called advertisement ID (advertisement identifier). As shown in FIG. 3(a), the user terminal identification information 330 is, for example, irregular character string information such as “a1b2c3d4 . . . xyz.”

The user terminal record information 220 is information including position information 230 on the user terminal 320 and operation record information 240 on the user terminal 320. As shown in FIG. 3(b), the position information 230 is information on the longitudes, latitudes, altitudes, or the like of places at which the user terminal 320 exists at specified dates and times, and is so-called GPS (Global Positioning System) information. The position information 230 is, for example, information expressed as “Dec. 10, 2018, 139°40′2″ east longitude, 35°40′25.2″ north latitude, 15 m above sea level.”

As shown in FIG. 3(c), the operation record information 240 is information on the operation records of the user terminal 320 and is, for example, a concept including applications that are operated on the user terminal 320, information that associates the applications and operation records on the applications with each other, information that associates the applications and search records on the applications with each other, information on web sites browsed by the applications, or the like. The operation record information 240 is, for example, information expressed as “Dec. 10, 2018, operated application: Youtxbe, operation content: browse moving image, browsing site: https://www.youtxbe.com/xxx xx.”

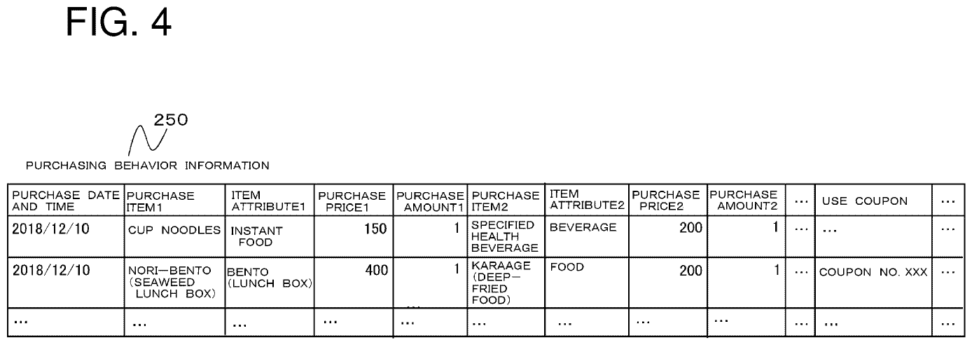

The purchasing behavior information 250 is information on purchasing of the items/services 280 at the real shop 350 that sells the items/services 280. As shown in FIG. 4, the purchasing behavior information 250 is a concept including the items/services 280 purchased at the real shop 350, purchase prices, purchase dates and times, purchase amounts, and attributes of the items/services 280, the use statuses of the advertisement information 210, or the like.

The purchasing behavior information 250 is, for example, information showing the fact that cup needles and a specified health beverage were purchased at the same time on Dec. 10, 2018. Further, the purchasing behavior information 250 is, for example, information showing the fact that a nori-bento (seaweed lunch box) and karaage (deep-fried food) were purchased in combination at the same time using the coupon No. xxx.

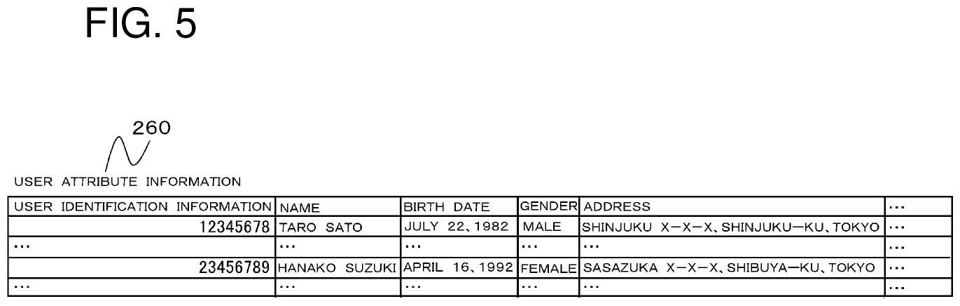

The user attribute information 260 is attribute information that includes the names, birth dates, genders, addresses, membership ranks, remaining points, or the like of the user 300 and is used to specify the user 300, and is information collected when the user 300 joins a specific service. The user identification information 310 is information used to identify the user 300 who operates the user terminal 320, and is information showing a membership ID (membership number) in a specific service where the user 300 joins. As shown in FIG. 5, the user attribute information 260 is information such as “Name: Taro Sato, Birth Date: Jul. 22, 1982, Gender: Male, Address: Shinjuku x-x-x, Shinjuku-ku, Tokyo” that is associated with the user identification information 310.

The examination result information 270 is information including information showing examination results obtained by an examination kit capable of examining the health conditions of the user 300 or meal data. The examination result information 270 is, for example, information showing various index values on a blood examination.

The user terminal information acquisition means 120 acquires the user terminal identification information 330, the user identification information 310, and the user terminal record information 220 that are collected by the user terminal 320 (software installed in the user terminal 320) from the user terminal 320 in association with each other.

The purchasing behavior information acquisition means 130 acquires the user identification information 310 and the purchasing behavior information 250 on the user 300 at the real shop 350 that are acquired by the shop terminal 360 provided in the real shop 350 that sells the items/services 280 from the shop terminal 360 in association with each other. Further, the purchasing behavior information acquisition means 130 may acquire the user identification information 310 and the result information 270 on a medical examination undergone by the user 300 at the real shop 350 that are acquired by the shop terminal 360 from the shop terminal 360 in association with each other.

Note that the shop terminal 360 may read the user identification information 310 from a recording medium (such as a card) or the user terminal 320 (a display device provided in the user terminal 320). Further, the shop terminal 360 may refer to authentication information storage means for storing a facial image of the user 300 and the user identification information 310 in association with each other and specify the user identification information 310 from the facial image of the user 300 that is acquired at the real shop 350.

The advertisement information generation means 140 analyzes the user terminal record information 220, the purchasing behavior information 250, the user attribute information 260, and the examination result information 270 that are stored in the user information storage means 110 and associated with each other by the user identification information 310. The analysis by the advertisement information generation means 140 is analysis made to generate the advertisement information 210 expecting a high degree of effectiveness from the position information 230, the operation record information 240, the purchasing behavior information 250, the attribute information 300, and the examination result information 270 on the user 300.

The above analysis includes but not limited to, for example, extracting the user 300 existing near the real shop 350, predicting a specific purchasing tendency such as combined purchasing and extracting the user 300 corresponding to the tendency, or extracting the user 300 assumed to have a specific need on the basis of a hypothesis. That is, the advertisement information generation means 140 specifies the user 300 (user identification information 310) who is more likely to be driven to purchase the items/services 280 by the notification of the advertisement information 210.

The advertisement information generation means 140 generates the advertisement information 210 to be notified to the advertisement application 290 installed in the user terminal 320 identified by the user terminal identification information 330 associated with the user identification information 310 specified to give notification of the advertisement information 210. The advertisement information generation means 140 may select a proper one of a plurality of the advertisement information 210 prepared in advance or may appropriately select and combine constituting elements of the advertisement information 210 together according to the conditions of the user 300 to which the advertisement information 210 is to be notified.

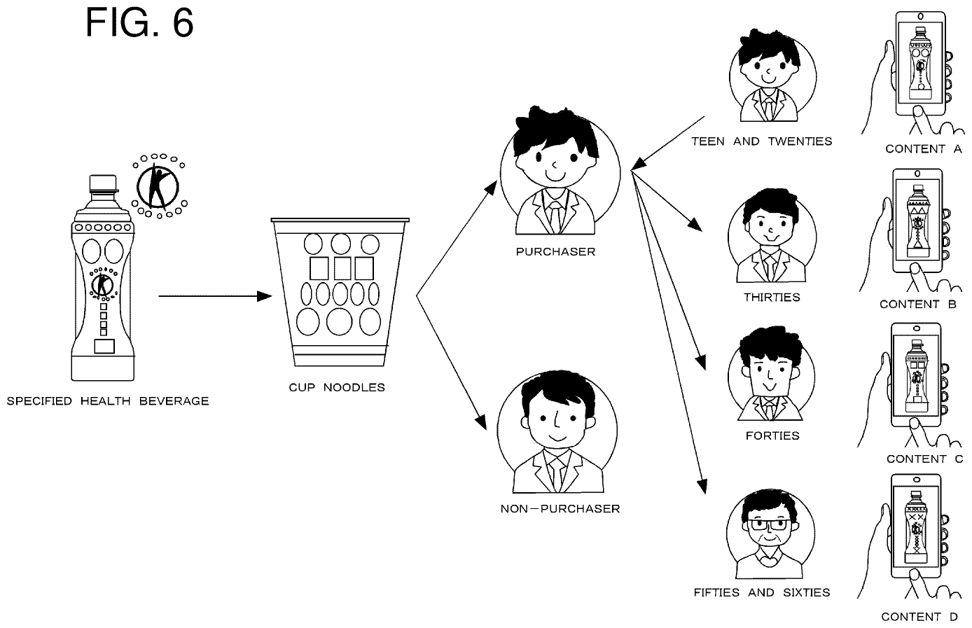

As shown in FIG. 6, the advertisement information generation means 140 generates the advertisement information 210 assumed to be suitable for each of the users 300 divided into segments on the basis of the analysis as described above and gives notification of the advertisement information 210 generated for each of the segments to the user terminal 320 operated by each of the users 300. A method for dividing the users 300 into the segments is not particularly limited since it varies depending on the features, analysis viewpoints, or the like of the user terminal record information 220, the purchasing behavior information 250, the user attribute information 260, and the examination result information 270 that are to be analyzed.

The advertisement information notification means 150 specifies the user terminal identification information 330 specified by the advertisement information generation means 140 and the advertisement application 290 and gives notification of the advertisement information 210 generated by the advertisement information generation means 140. The advertisement information notification means 150 may give instructions to display the advertisement information 210 on the advertisement application 290 installed in the user terminal 320 identified by the user terminal identification information 330 to the server apparatus 340 that manages the distribution of the advertisement information 210 to the advertisement application 290. Further, the advertisement information notification means 150 itself may perform processing to display the advertisement information 210 on the advertisement application 290 installed in the user terminal 320 identified by the user terminal identification information 330.

The advertisement information notification means 150 may give notification of the advertisement information 210 to an employee terminal 380 or the shop terminal 360 that is operated by an employee of the real shop 350 relevant to the advertisement information 210. The prior confirmation of the advertisement information 210 by the employee of the real shop 350 relevant to the advertisement information 210 makes it possible to properly respond to the user 300 who comes to the shop according to the advertisement information 210 and enhance the effect of the advertisement information 210.

The advertisement effect verification means 160 verifies, when the purchasing behavior information 250 includes the use status of the advertisement information 210, the effect of the advertisement information 210 on the basis of the advertisement information 210 notified from the advertisement information notification means 150 and the use status of the advertisement information 210 stored in the user information storage means 110. The advertisement effect verification means 160 can directly verify the use status of the advertisement information 210 notified to the user 300. The advertisement effect verification means 160 may verify the effect of the advertisement information 210 on the basis of the advertisement information 210 notified from the advertisement information notification means 150 and the purchasing behavior information 250 relevant to the items/services 280 included in the advertisement information 210.

On the basis of the principle of the operation described above, the present apparatus 100 can give notification of the advertisement 210 assumed to be highly effective and evaluate the effect of the advertisement 210 in consideration of the current statuses 220, 260, and 270 and the preference tendencies 250 of the user 300.

### Hardware Configuration of Advertisement Apparatus According to Present Embodiment

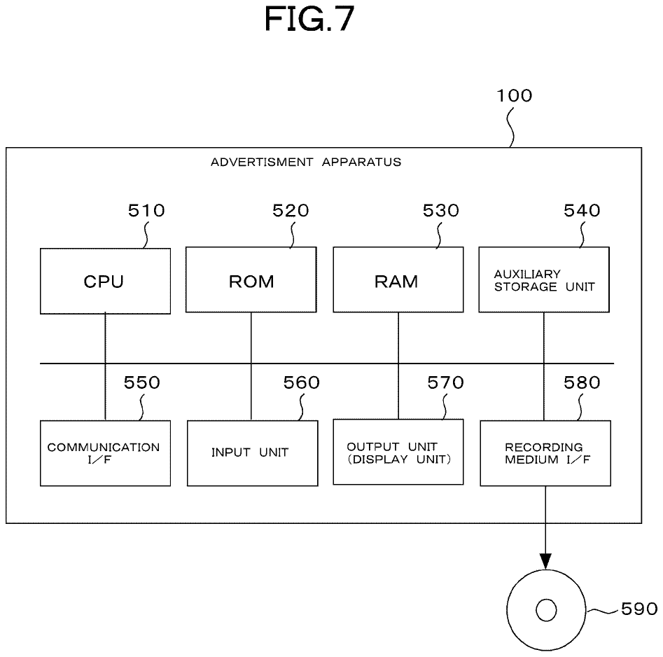

A hardware configuration example of the present apparatus 100 will be described using FIG. 7. FIG. 7 is a diagram showing an example of the hardware configuration of the present apparatus 100. As shown in FIG. 7, the present apparatus 100 has a CPU (Central Processing Unit) 510, a ROM (Read-Only Memory) 520, a RAM (Random Access Memory) 530, an auxiliary storage unit 540, a communication I/F 550, an input unit 560, a display unit 570, and a recording medium I/F 580.

The CPU 510 is a unit that performs a program stored in the ROM 520, and performs the arithmetic processing of data developed (loaded) in the RAM 530 according to a program command to control the whole present apparatus 100. The ROM 520 stores a program or data that is to be performed by the CPU 510. When the CPU 510 performs a program stored in the ROM 520, a program or data performed is developed (loaded) in the RAM 530. The RAM 530 temporarily retains computation data during computation.

The auxiliary storage unit 540 is a unit that stores an OS (Operating System) that is basic software, an application program according to the present embodiment, or the like together with associated data. The auxiliary storage unit 540 includes the storage means 110 and is, for example, a HDD (Hard Disc Drive), flash memory, or the like.

The communication I/F 550 is an interface that is connected to the communication network 390 such as a wired/wireless LAN (Local Area Network) and the Internet and used to transfer data to the apparatuses 320, 340, 360, and 380 that offer communication functions.

The input unit 560 is a unit such as a keyboard used to input data to the present apparatus 100. The display unit (output unit) 570 is a unit that is constituted by a LCD (Liquid Crystal Display) or the like and functions as a user interface when a user uses functions provided in the present apparatus 100 or performs various settings on the functions. The recording medium I/F 580 is an interface used to transmit and receive data to and from the recording medium 590 such as a CD-ROM, a DVD-ROM, and a USB memory.

The respective means provided in the present apparatus 100 may be realized when the CPU 510 performs a program that is stored in the ROM 520 or the auxiliary storage unit 540 and corresponds to the respective means. Further, the respective means provided in the present apparatus 100 may be realized in such a manner that processing relevant to the respective means is performed by hardware. Further, the present apparatus 100 may be caused to read a program according to the present invention from an external server apparatus via the communication I/F 550 or from the recording medium 590 via the recording medium I/F 580 to perform the same.

### Processing Example by Advertisement Apparatus According to Present Embodiment

### (1) Processing to Acquire User Terminal Record Information 220 by Present Apparatus 100

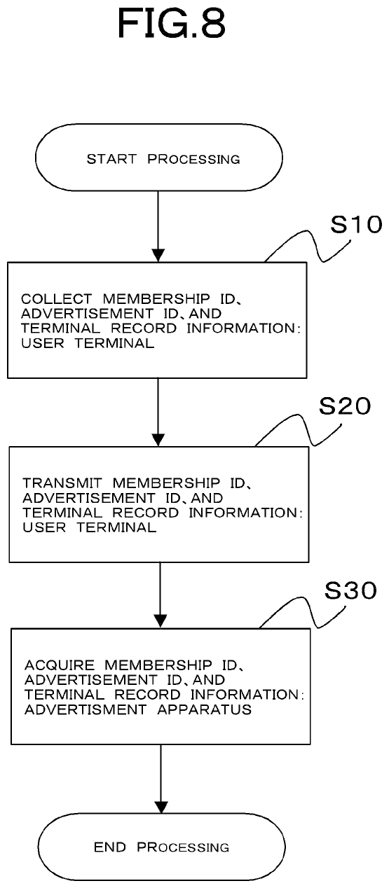

The flow of an example of processing to acquire the user terminal record information 220 by the present apparatus 100 will be described using FIG. 8. FIG. 8 is a flowchart showing the flow of the example of the processing to acquire the user terminal record information 220 by the present apparatus 100.

In S10, the user terminal 320 collects the user terminal record information 220, the user identification information 310, and the user terminal identification information 330 on the user terminal 320. The user terminal record information 220 includes the position information 230 on the user terminal 320 and the operation record information 240 in the user terminal 320.

The user identification information 310 is information used to identify the user 300 who operates the user terminal 320 and shows a membership ID (identification number) in a specific service where the user 300 joins.

The user terminal identification information 330 is information used to specify the user terminal 320 when the application 290 installed in the user terminal 320 is specified to give notification of an advertisement, and is mentioned as a so-called advertisement ID (advertisement identifier). As shown in FIG. 3(a), the user terminal identification information 330 is, for example, irregular character string information such as “a1b2c3d4 . . . xyz.”

As shown in FIG. 3(b), the position information 230 is information on the longitudes, latitudes, altitudes, or the like of places at which the user terminal 320 exists at specified dates and times, and is so-called GPS (Global Positioning System) information. The position information 230 is, for example, information expressed as “Dec. 10, 2018, 139°40′2″ east longitude, 35°40′25.2″ north latitude, 15 m above sea level.”

As shown in FIG. 3(c), the operation record information 240 is information on the operation records of the user terminal 320 and is, for example, a concept including applications that are operated on the user terminal 320, information that associates the applications and operation records on the applications with each other, information that associates the applications and search records on the applications with each other, information on web sites browsed by the applications, or the like. The operation record information 240 is, for example, information expressed as “Dec. 10, 2018, operated application: Youtxbe, operation content: browse moving image, browsing site: https://www.youtxbe.com/xxx xx.”

In S20, the user terminal 320 associates the user terminal record information 220, the user identification information 310, and the user terminal identification information 330 on the user terminal that are collected in S10 with each other and gives notification of the associated information to the present apparatus 100.

In S30, the user terminal information acquisition means 120 acquires the user terminal record information 220, the user identification information 310, and the user terminal identification information 330 on the user terminal 320 that are notified in S20. Then, the user terminal information acquisition means 120 causes the user information storage means 110 to store the acquired user terminal record information 220 and the user terminal identification information 330 on the user terminal 320 in association with the user identification information 310. By performing the above processing, the present apparatus 100 can collect and store the information 220, 310, and 330 that serves as a basis for the generation/notification of the advertisement information 210.

### (2) Processing to Acquire Purchasing Behavior Information 250 by Present Apparatus 100

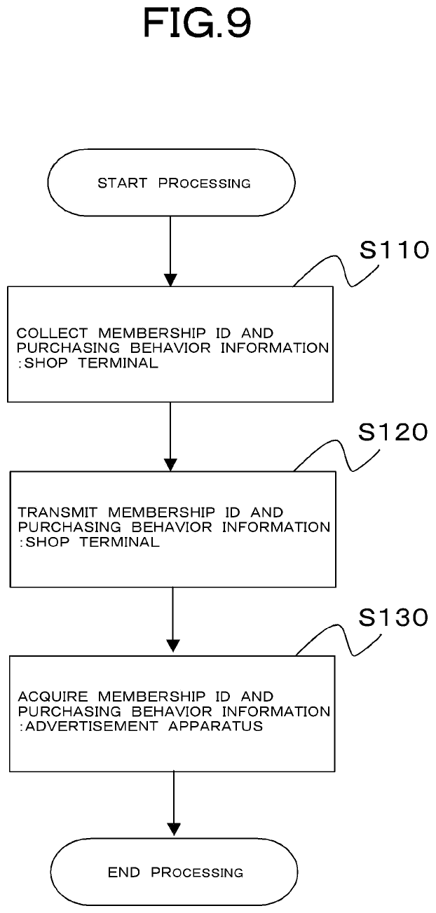

The flow of an example of processing to acquire the purchasing behavior information 250 by the present apparatus 100 will be described using FIG. 9. FIG. 9 is a flowchart showing the flow of the example of the processing to acquire the purchasing behavior information 250 by the present apparatus 100.

In S110, the shop terminal 360 collects the user identification information 310 and the purchasing behavior information 250 on the user 300 who operates the user terminal 320. The shop terminal 360 may read the user identification information 310 from a recording medium (such as a card) or the user terminal 320. Further, the shop terminal 360 may refer to the authentication information storage means for storing a facial image of the user 300 and the user identification information 310 in association with each other and specify the user identification information 310 from the facial image of the user 300 that is acquired at the real shop 350.

As shown in FIG. 4, the purchasing behavior information 250 is a concept including the items/services 280 purchased at the real shop 350, purchase prices, purchase dates and times, purchase amounts, and attributes of the items/services 280, the use statuses of the advertisement information 210, or the like. The purchasing behavior information 250 is, for example, information showing the fact that cup needles and a specified health beverage were purchased at the same time on Dec. 10, 2018. Further, the purchasing behavior information 250 is, for example, information showing the fact that a nori-bento (seaweed lunch box) and karaage (deep-fried food) were purchased in combination at the same time using the coupon No. xxx.

In S110, the shop terminal 360 may collect the user identification information 310 and the examination result information 270 on the user 300 who operates the user terminal 320. The examination result information 270 is information showing examination results obtained by an examination kit capable of examining the health conditions of the user 300, and is, for example, information showing various index values or the like on a blood examination.

In S120, the shop terminal 360 associates the user identification information 310, the purchasing behavior information 250, and the examination result information 270 on the user 300 who purchased the items/services 280 at the real shop 350 that are collected in S110 with each other and gives notification of the associated information to the present apparatus 100.

In S130, the purchasing behavior information acquisition means 130 acquires the user identification information 310, the purchasing behavior information 250, and the examination result information 270 on the user 300 who purchased the items/services 280 at the real shop 350 that are notified in S120 in association with each other. Then, the purchasing behavior information acquisition means 130 causes the user information storage means 110 to store the acquired purchasing behavior information 250 and the examination result information 270 on the user 300 in association with the user identification information 310. By performing the above processing, the present apparatus 100 can collect and store the information 250, 270, and 310 that serves as a basis for the generation/notification of the advertisement information 210.

### (3) Processing to Verify Generation/Notification/Effect of Advertisement Apparatus 210 by Present Apparatus 100

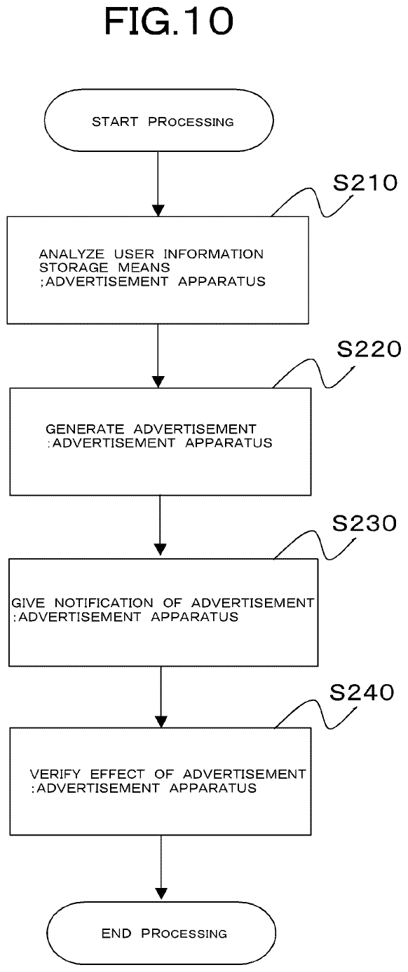

The flow of an example of processing to verify the generation/notification/effect of the advertisement information 210 by the present apparatus 100 will be described using FIG. 10. FIG. 10 is a flowchart showing the flow of the example of the processing to verify the generation/notification/effect of the advertisement information 210 by the present apparatus 100.

In the user information storage means 110, the user terminal identification information 330, the user terminal record information 220, the purchasing behavior information 250, the examination result information 270, and the user attribute information 260 are stored in association with each other by the user identification information 310.

The user attribute information 260 is attribute information that includes the names, birth dates, genders, addresses, or the like of the user 300 and is used to specify the user 300, the attribute information being information collected when the user 300 joins a specific service. As shown in FIG. 5, the user attribute information 260 is information such as “Name: Taro Sato, Birth Date: Jul. 22, 1982, Gender: Male, Address: Shinjuku x-x-x, Shinjuku-ku, Tokyo” that is associated with the user identification information 310.

In S210, the advertisement information generation means 140 analyzes the user terminal record information 220, the purchasing behavior information 250, the user attribute information 260, and the examination result information 270 that are stored in the user information storage means 110 and associated with each other by the user identification information 310. The analysis by the advertisement information generation means 140 is analysis made to generate the advertisement information 210 expecting a high degree of effectiveness from the position information 230, the operation record information 240, the purchasing behavior information 250, the attribute information 300, and the examination result information 270 on the user 300 (user terminal 320).

The above analysis includes but not limited to, for example, extracting the user 300 existing near the real shop 350, predicting a specific purchasing tendency such as combined purchasing and extracting the user 300 corresponding to the tendency, or extracting the user 300 assumed to have a specific need on the basis of a hypothesis. That is, the advertisement information generation means 140 specifies the user 300 (user identification information 310) who is more likely to be driven to purchase the items/services 280 by the notification of the advertisement information 210.

In S220, the advertisement information generation means 140 generates the advertisement information 210 to be notified to the advertisement application 290 installed in the user terminal 320 identified by the user terminal identification information 330 associated with the user identification information 310 specified in S210.

The advertisement information generation means 140 may select a proper one of a plurality of the advertisement information 210 prepared in advance or may appropriately select and combine constituting elements of the advertisement information 210 together according to the conditions of the user 300 to which the advertisement information 210 is to be notified.

As shown in FIG. 6, the advertisement information generation means 140 generates the advertisement information 210 assumed to be suitable for each of the users 300 divided into segments on the basis of the analysis as described above and gives notification of the advertisement information 210 generated for each of the segments to the user terminal 320 operated by each of the users 300. A method for dividing the users 300 into the segments is not particularly limited since it varies depending on the features, analysis viewpoints, or the like of the user terminal record information 220, the purchasing behavior information 250, the user attribute information 260, and the examination result information 270 that are to be analyzed.

In S230, the advertisement information notification means 150 gives notification of the advertisement information 210 generated in S220 to the user terminal identification information 330 specified in S210 and the advertisement application 290. The advertisement information notification means 150 may give instructions to display the advertisement information 210 on the advertisement application 290 installed in the user terminal 320 identified by the user terminal identification information 330 to the server apparatus 340.

Further, the advertisement information notification means 150 itself may perform processing to display the advertisement information 210 on the advertisement application 290 installed in the user terminal 320 identified by the user terminal identification information 330.

In S230, the advertisement information notification means 150 may give notification of the advertisement information 210 to the employee terminal 380 or the shop terminal 360 that is operated by an employee of the real shop 350 relevant to the advertisement information 210. The prior confirmation of the advertisement information 210 by the employee of the real shop 350 relevant to the advertisement information 210 makes it possible to properly respond to the user 300 who comes to the shop according to the advertisement information 210 and enhance the effect of the advertisement information 210.

In S240, the advertisement effect verification means 160 verifies the effect of the advertisement information 210 on the basis of the advertisement information 210 notified in S230 and the purchasing behavior information 250 relevant to the items/services/education 280 included in the advertisement information 210. The advertisement effect verification means 160 verifies, when the purchasing behavior information 250 includes the use status of the advertisement information (for example, a coupon or the like) 210, the effect of the advertisement information 210 on the basis of the advertisement information 210 notified in S230 and the use status of the advertisement information 210 stored in the user information storage means 110. Thus, the advertisement effect verification means 160 can directly verify the use status of the advertisement information 210 notified to the user 300.

By performing the above processing, the present apparatus 100 can give notification of the advertisement 210 assumed to be highly effective and evaluate the effect of the advertisement 210 in consideration of the current statuses 220, 260, and 270 and the preference tendencies 250 of the user 300.

The embodiment of the present invention is described in detail above. However, the present invention is not limited to the specific embodiment and may be modified/changed in various ways within the spirit of the present invention described in claims.

### REFERENCE SIGNS LIST

100 Advertisement apparatus
110 User information storage means
120 User terminal information acquisition means
130 Purchasing behavior information acquisition means
140 Advertisement information generation means
150 Advertisement information notification means
160 Advertisement effect verification means
210 Advertisement information
220 User terminal record information
230 Position information
240 Operation record information
250 Purchasing behavior information
260 User attribute information
270 Examination result information/meal data
280 Items/services/education
290 Advertisement application
300 User
310 User identification information
320 User terminal
330 User terminal identification information
340 Server apparatus
350 Real shop
360 Shop terminal
370 Authentication information storage means
380 Employee terminal
390 Communication network
510 CPU
520 ROM
530 RAM
540 Auxiliary storage unit
550 Communication interface
560 Input unit
570 Output unit
580 Recording medium interface
590 Recording medium

1. An advertisement apparatus comprising:
user terminal information acquisition means for acquiring user terminal identification information, user identification information, and user terminal record information that are collected by a user terminal from the user terminal,
the user terminal identification information being information used to specify the user terminal when the user terminal and an application installed in the user terminal are specified to give notification of an advertisement,
the user identification information identifying a user who operates the user terminal,
the user terminal record information including position information and operation record information on the user terminal;
purchasing behavior information acquisition means for acquiring the user identification information and purchasing behavior information that are acquired by a shop terminal provided in a real shop that sells an item/service from the shop terminal,
the purchasing behavior information being information relevant to purchasing of the item/service at the real shop by the user;
user information storage means for storing the information acquired by the user terminal information acquisition means and the purchasing behavior information acquisition means and user attribute information in association with each other by the user identification information,
the user attribute information including a name, a birth date, a gender, and an address of the user;
advertisement information generation means for generating advertisement information on a basis of an analysis result obtained by analyzing the information stored in the user information storage means,
the advertisement information being notified to an advertisement application that is installed in the user terminal identified by the user terminal identification information and capable of receiving an advertisement; and
advertisement information notification means for specifying the user terminal identification information and the advertisement application and giving notification of the advertisement information generated by the advertisement information generation means.

2. The advertisement apparatus according to claim 1, wherein
the advertisement information notification means gives instructions to display the advertisement information on the advertisement application installed in the user terminal identified by the user terminal identification information to the server apparatus that manages distribution of an advertisement to the advertisement application.

3. The advertisement apparatus according to claim 1, wherein
the purchasing behavior information acquisition means acquires examination result information obtained by an examination kit capable of examining a health condition of the user acquired by the shop terminal from the shop terminal.

4. The advertisement apparatus according to claim 1,
wherein,
when the shop terminal refers to authentication information storage means for storing a facial image of the user and the user identification information in association with each other and specifies the user identification information from the facial image of the user that is acquired at the real shop,
the purchasing behavior information acquisition means acquires the user identification information specified by the shop terminal from the shop terminal.

5. The advertisement apparatus according to claim 1, wherein
the advertisement information notification means gives notification of the advertisement information to an employee terminal or the shop terminal that is operated by an employee of the real shop relevant to the advertisement information.

6. The advertisement apparatus according to claim 1, wherein
the operation record information includes any one or more of an operated application, information that associates the operated application and an operation record on the application with each other, information that associates the operated application and a search record on the application with each other, and information on a web site browsed by the application.

7. The advertisement apparatus according to claim 1, wherein
the purchasing behavior information includes any one or more of an item/service that is purchased and a purchase price, a purchase date and time, a purchase amount, and an attribute of the item/service.

8. The advertisement apparatus according to claim 1,
comprising:
advertisement effect verification means for verifying an effect of the advertisement information on a basis of the advertisement information notified by the advertisement information notification means and a use status of the advertisement information that is stored in the user information storage means when the purchasing behavior information includes the use status of the advertisement information.

9. An advertisement method comprising in a computer:
a step of acquiring user terminal identification information, user identification information, and user terminal record information that are collected by a user terminal from the user terminal by a user terminal information acquisition means,
the user terminal identification information being information used to specify the user terminal when the user terminal and an application installed in the user terminal are specified to give notification of an advertisement,
the user identification information identifying a user who operates the user terminal,
user terminal record information including position information and operation record information on the user terminal;
a step of acquiring the user identification information and purchasing behavior information that are acquired by a shop terminal provided in a real shop that sells an item/service from the shop terminal by purchasing behavior information acquisition means,
the purchasing behavior information being information relevant to purchasing of the item/service at the real shop by the user;
a step of generating advertisement information on a basis of an analysis result obtained by analyzing the information stored in user information storage means by advertisement information generation means,
the advertisement information being notified to an advertisement application that is installed in the user terminal identified by the user terminal identification information and capable of receiving an advertisement,
the user information storage means storing the information acquired by the user terminal information acquisition means and the purchasing behavior information acquisition means and user attribute information in association with each other by the user identification information,
the user attribute information including a name, a birth date, a gender, and an address of the user; and
a step of specifying the user terminal identification information and the advertisement application and giving notification of the advertisement information generated by the advertisement information generation means by advertisement information notification means.

10. The advertisement method according to claim 9, wherein
the advertisement information notification means gives instructions to display the advertisement information on the advertisement application installed in the user terminal identified by the user terminal identification information to the server apparatus that manages distribution of an advertisement to the advertisement application.

11. The advertisement method according to claim 9, wherein
the purchasing behavior information acquisition means acquires examination result information obtained by an examination kit capable of examining a health condition of the user acquired by the shop terminal from the shop terminal.

12. The advertisement method according to claim 9, wherein,
when the shop terminal refers to authentication information storage means for storing a facial image of the user and the user identification information in association with each other and specifies the user identification information from the facial image of the user that is acquired at the real shop,
the purchasing behavior information acquisition means acquires the user identification information specified by the shop terminal from the shop terminal.

13. The advertisement method according to claim 9, wherein
the advertisement information notification means gives notification of the advertisement information to an employee terminal or the shop terminal that is operated by an employee of the real shop relevant to the advertisement information.

14. The advertisement method according to claim 9, wherein
the operation record information includes any one or more of an operated application, information that associates the operated application and an operation record on the application with each other, information that associates the operated application and a search record on the application with each other, and information on a web site browsed by the application.

15. The advertisement apparatus according to claim 9,
wherein
the purchasing behavior information includes any one or more of an item/service that is purchased and a purchase price, a purchase date and time, a purchase amount, and an attribute of the item/service.

16. The advertisement method according to claim 9,
comprising:
a step of verifying an effect of the advertisement information on a basis of the advertisement information notified by the advertisement information notification means and a use status of the advertisement information that is stored in the user information storage means by advertisement effect verification means when the purchasing behavior information includes the use status of the advertisement information.

17. An advertisement program for causing a computer to perform the method according to claim 9.
